(19) United States
(12) Patent Application Publication
(10) Pub. No.: US 2013/0038546 A1
(43) Pub. Date: Feb. 14, 2013

(54) ELECTRONIC DEVICE, ADJUSTMENT AMOUNT CONTROL METHOD AND RECORDING MEDIUM

(71) Applicant: Shigeki MINEO, Tokyo (JP)

(72) Inventor: Shigeki MINEO, Tokyo (JP)

(73) Assignee: CASIO COMPUTER CO., LTD., Tokyo (JP)

(21) Appl. No.: 13/563,875

(22) Filed: Aug. 1, 2012

(30) Foreign Application Priority Data
Aug. 9, 2011 (JP) 2011-173629

(51) Int. Cl. G06F 3/041

(52) U.S. Cl. 345/173

(57) ABSTRACT

The present invention enables a user to make adjustment with less stress, while preventing discomfort to or adverse effects on the user. During video playback, music playback, image-capturing, etc., a display panel displays a slide bar. Then, when a user performs a slide operation on the slide bar on the touch panel, and the speed of the slide operation is judged to be faster than a set speed, a control section controls an adjustment amount based on the set speed. Conversely, when the speed of the slide operation is judged to be slower than the set speed, the control section controls the adjustment amount based on the speed of the slide operation. At this stage, a touch display section displays an adjustment position based on the slide operation, a position corresponding to the controlled adjustment amount, etc., in association with the slide bar.

### CROSS-REFERENCE TO RELATED APPLICATION

This application is based upon and claims the benefit of priority from the prior Japanese Patent Application No. 2011-173629, filed Aug. 9, 2011, the entire contents of which is incorporated herein by reference.

### BACKGROUND OF THE INVENTION

1. Field of the Invention

The present invention relates to an electronic device, an adjustment amount control method and a recording medium.

2. Description of the Related Art

There are a number of conventional devices whose sound volume control is performed by an electronic volume control. However, when the sound volume is changed in real time in response to a rapid volume change operation, the playback volume suddenly changes, which may adversely impact the user's ears. Accordingly, for example, Japanese Patent Application Laid-Open (Kokai) Publication No. 11-068484 discloses a technique for an electronic volume control by which a sudden increase of sound volume when it is consecutively increased in a high volume adjustment range of an amplifier can be suppressed, and the sound volume can be rapidly decreased when it is consecutively decreased in the high volume adjustment range.

In the above-described conventional technique, a rotary switch is used. However, in some electronic volume controls, a slider is used. As compared to electronic volume controls using a rotary switch, the electronic volume controls using a slider have a greater adverse effect in that the user's finger may accidentally slip and more suddenly change the volume. Accordingly, there is a problem in that the user is required to move and adjust the slider while checking the change in volume, which causes the user to feel stress or discomfort. This problem is a common issue that exists not only in sound volume adjustment but in adjustment in general, such as the adjustment of water content, airflow rate, temperature or lens movement amount.

An object of the present invention is to provide an electronic device and a program capable of preventing discomfort to or adverse effects on a user.

### SUMMARY OF THE INVENTION

In order to achieve the above-described object, in accordance with one aspect of the present invention, there is provided an electronic device comprising: a display section; a position specifying section which specifies a position on the display section; a slider display section which displays on the display section a slider for adjusting an adjustment amount of a function provided by the electronic device; an adjustment position display section which displays an adjustment position corresponding to the position specified by a slide operation performed on the slider by a user using the position specifying section, in association with the slider displayed by the slider display section; a judging section which judges whether a speed of the slide operation by the user is faster than a predetermined speed of change for the adjustment amount; a control section which controls the adjustment amount to be changed at a speed slower than the speed of the slide operation by the user, when the judging section judges that the speed of the slide operation by the user is faster than the predetermined speed of change for the adjustment amount; and a control position display section which displays a position corresponding to the adjustment amount controlled by the control section, in association with the slider.

In accordance with another aspect of the present invention, there is provided an electronic device comprising: a display section; a position specifying section which specifies a position on the display section; a slider display section which displays on the display section a slider for adjusting an adjustment amount of a function provided by the electronic device; an adjustment position display section which displays an adjustment position corresponding to a position specifying operation performed on an adjustment position on the slider by a user using the position specifying section, in association with the slider displayed by the slider display section; a judging section which judges whether an operation performed on the slider by the user is a position specifying operation on an adjustment position; a control section which (i) controls the adjustment amount to be changed to a level corresponding to the adjustment position displayed by the adjustment position display section, at a speed corresponding to a predetermined speed of change for the adjustment amount, and (ii) stops change of the adjustment amount, when the judging section judges that the operation performed on the slider by the user is a position specifying operation on an adjustment position; and a control position display section which displays a position corresponding to the adjustment amount controlled by the control section, in association with the slider.

In accordance with another aspect of the present invention, there is provided a method of controlling an adjustment amount in an electronic device including a display section and a position specifying section which specifies a position on the display section, comprising: a slider display step of displaying on the display section a slider for adjusting an adjustment amount of a function provided by the electronic device; an adjustment position display step of displaying an adjustment position corresponding to the position specified by a slide operation performed on the slider by a user using the position specifying section, in association with the slider displayed in the slider display step; a judging step of judging whether a speed of the slide operation by the user is faster than a predetermined speed of change for the adjustment amount; a control step of controlling the adjustment amount to be changed at a speed slower than the speed of the slide operation by the user, when the speed of the slide operation by the user is judged to be faster than the predetermined speed of change for the adjustment amount in the judging step; and a control position display step of displaying a position corresponding to the adjustment amount controlled in the control step, in association with the slider.

In accordance with another aspect of the present invention, there is provided a method of controlling an adjustment amount in an electronic device including a display section and a position specifying section which specifies a position on the display section, comprising: a slider display step of displaying on the display section a slider for adjusting an adjustment amount of a function provided by the electronic device; an adjustment position display step of displaying an adjustment position corresponding to a position specifying operation performed on an adjustment position on the slider by a user using the position specifying section, in association with the slider displayed in the slider display step; a judging step of judging whether an operation performed on the slider by the user is a position specifying operation on an adjustment position; a control step of (i) controlling the adjustment amount to be changed to a level corresponding to the adjustment position displayed in the adjustment position display step, at a speed corresponding to a predetermined speed of change for the adjustment amount, and (ii) stopping change of the adjustment amount, when the operation performed on the slider by the user is judged to be a position specifying operation on an adjustment position in the judging step; and a control position display step of displaying a position corresponding to the adjustment amount controlled in the control step, in association with the slider.

In accordance with another aspect of the present invention, there is provided a non-transitory computer-readable storage medium having stored thereon a program that is executable by a computer in an electronic device including a display section and a position specifying section which specifies a position on the display section, the program being executable by the computer to perform functions comprising: a slider display function for displaying on the display section a slider for adjusting an adjustment amount of a function provided by the electronic device; an adjustment position display function for displaying an adjustment position corresponding to the position specified by a slide operation performed on the slider by a user using the position specifying section, in association with the slider displayed by the slider display function; a judging function for judging whether a speed of the slide operation by the user is faster than a predetermined speed of change for the adjustment amount; a control function for controlling the adjustment amount to be changed at a speed slower than the speed of the slide operation by the user, when the speed of the slide operation by the user is judged by the judging function to be faster than the predetermined speed of change for the adjustment amount; and a control position display function for displaying a position corresponding to the adjustment amount controlled by the control function, in association with the slider.

In accordance with another aspect of the present invention, there is provided a non-transitory computer-readable storage medium having stored thereon a program that is executable by a computer in an electronic device including a display section and a position specifying section which specifies a position on the display section, the program being executable by the computer to perform functions comprising: a slider display function for displaying on the display section a slider for adjusting an adjustment amount of a function provided by the electronic device; an adjustment position display function for displaying an adjustment position corresponding to a position specifying operation performed on an adjustment position on the slider by a user using the position specifying section, in association with the slider displayed by the slider display function; a judging function for judging whether an operation performed on the slider by the user is a position specifying operation on an adjustment position; a control function for (i) controlling the adjustment amount to be changed to a level corresponding to the adjustment position displayed by the adjustment position display function, at a speed corresponding to a predetermined speed of change for the adjustment amount, and (ii) stopping change of the adjustment amount, when the operation performed on the slider by the user is judged by the judging function to be a position specifying operation on an adjustment position; and a control position display function for displaying a position corresponding to the adjustment amount controlled by the control function, in association with the slider.

According to the present invention, discomfort to or adverse effects on a user are prevented.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the structure of an electronic device 1 according to an embodiment of the present invention;

FIG. 2 is a conceptual diagram showing an example of a set speed table for sound volume adjustment 71 according to the present embodiment, which is used for performing sound volume adjustment during video playback or music playback;

FIG. 3 is a conceptual diagram showing an example of a set speed table for zoom amount adjustment 72 according to the present embodiment, which is used for performing zoom adjustment during image-capturing;

FIG. 4A and FIG. 4B are schematic diagrams showing examples of sound volume adjustment slide bars 10a and 10b according to the present embodiment;

FIG. 5A and FIG. 5B are schematic diagrams showing examples of zoom amount adjustment slide bars 20a and 20b according to the present embodiment;

FIG. 6A and FIG. 6B are schematic diagrams showing other examples of the sound volume adjustment slide bars 10a and 10b according to the present embodiment;

FIG. 7A and FIG. 7B are schematic diagrams showing other examples of the zoom amount adjustment slide bars 20a and 20b according to the present embodiment;

FIG. 8A and FIG. 8B are schematic diagrams showing other examples of the sound volume adjustment slide bars 10a and 10b according to the present embodiment;

FIG. 9A and FIG. 9B are schematic diagrams showing other examples of the zoom amount adjustment slide bars 20a and 20b according to the present embodiment;

FIG. 10A to FIG. 10C are conceptual diagrams of slide speed, set speed, and actual change in sound volume when the sound volume is controlled in a direction of increase in the present embodiment;

FIG. 11A to FIG. 11C are conceptual diagrams of slide speed, set speed, and actual change in sound volume when the sound volume is controlled in a direction of decrease in the present embodiment;

FIG. 12 is a flowchart for explaining operations (main routine) of the electronic device 1 according to the present embodiment;

FIG. 13 is also a flowchart for explaining operations (main routine) of the electronic device 1 according to the present embodiment;

FIG. 14 is a flowchart for explaining the operation of adjustment amount control processing according to the present embodiment; and

FIG. 15 is also a flowchart for explaining the operation of the adjustment amount control processing according to the present embodiment.

### DETAILED DESCRIPTION OF THE PREFERRED EMBODIMENTS

The present invention divides response display for an operation for changing the amount of control by a slider of a touch interface into display responding to a user operation and display showing an actual change in the control amount, and changes the control amount at a suitable speed set so as not to cause discomfort to or adverse effects on the user, while displaying the final amount of the change in control.

For example, in a case where the control amount is sound volume, the actual change in the sound volume follows a volume change operation performed by the user, in a low volume range. In a medium and high volume ranges, the acceleration of the actual change in the sound volume is reduced in relation to the volume change operation performed by the user. As a result, adjustment can be made by an amount causing minimal stress, while preventing discomfort to or adverse effects on the user which are attributed to sudden change in sound volume.

An embodiment of the present invention will hereinafter be described with reference to the drawings.

A. Configuration of the Embodiment

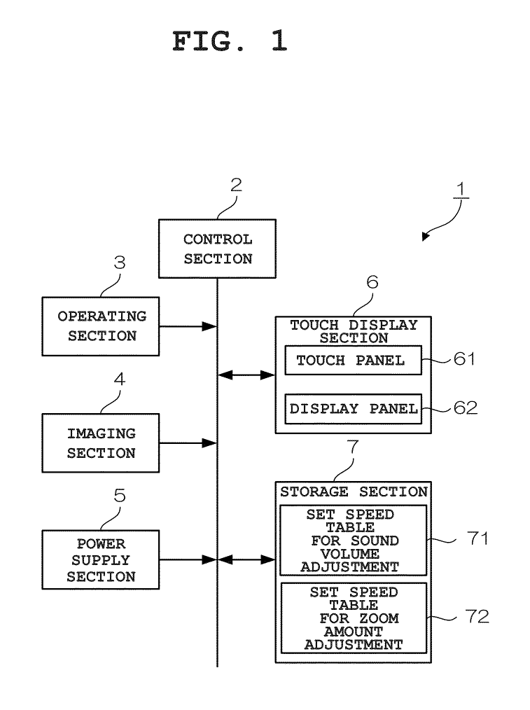

FIG. 1 is a block diagram showing the structure of an electronic device 1 according to the embodiment of the present invention. In FIG. 1, the electronic device 1 is an electronic device having image-capturing and playback functions, such as a mobile phone, a smart phone, a personal digital assistant (PDA), a digital camera or a tablet terminal, and includes a control section 2, an operating section 3, an imaging section 4, a power supply section 5, a touch display section (touch panel 61 and display panel 62) 6, and a storage section 7.

The control section 2 is a single-chip microcomputer that controls each section of the electronic device 1. In particular, according to the present embodiment, when a user performs a slide operation on the touch panel 61 (described hereafter) to adjust sound volume during video playback or music playback, or to adjust the amount of zoom during video image-capturing, the control section 2 controls the adjustment of sound volume during video playback or music playback, or zoom amount during video image-capturing, in accordance with parameters such as a position corresponding to the slide operation, its slide direction and slide speed, and preset speed.

Also, in consideration of users performing a direct touch operation on a point corresponding to a volume level to which they wish to adjust sound volume rather than performing a slide operation, when a user performs a touch operation on the touch panel 61 (described hereafter), the control section 2 controls the adjustment of sound volume during video playback or music playback, or zoom amount during video image-capturing, in accordance with parameters such as a point touched by the touch operation, its increase/decrease direction, and preset speed.

In particular, the present invention divides response display for an operation for changing the amount of adjustment by a slider of a touch interface into display responding to the operation and display showing actual change in the adjustment amount, and changes the adjustment amount at a suitable speed set so as not to cause discomfort to or adverse effects on the user, while displaying the final amount of the change in adjustment. Accordingly, in the present invention, a change in adjustment amount made by a user operation may differ from an actual change in the adjustment amount. Therefore, the control section 2 controls the display of a slide bar used for sound volume adjustment during video playback or music playback or a slide bar used for zoom amount adjustment during video image-capturing which are displayed on the display panel 62, so as not to cause discomfort to or adverse effects on the user.

The operating section 3 includes a plurality of operation keys, such as a power button, and outputs operation signals based on key operations by the user to the control section 2. The imaging section 4, which includes a focus lens, a zoom lens, an image sensor, and the like, forms an image of a subject on the image sensor, and after converting the light of the captured subject into electrical signals, outputs the electrical signals. The power supply section 5 includes, for example, a secondary battery and supplies power to each section.

The touch display section 6 includes the touch panel 61 and the display panel 62. The display panel 62 includes a color liquid crystal display, an organic electroluminescence (EL) display, a backlight, and driver circuits thereof, and displays various data and images and videos captured by the imaging section 4. In particular, according to the present embodiment, the display panel 62 displays a slide bar that is used to set sound volume during, for example, video playback or music playback.

The touch panel 61 is a transmissive touch sensor provided on the display panel 62, and its touch points are correlated with points (coordinates) on the display panel 62. In particular, according to the present embodiment, the touch panel 61 is used to adjust sound volume or zoom amount, by a slide operation being performed on the slide bar displayed on the display panel 62 or a touch operation being performed on a desired point on the slide bar during video playback, music playback, image-capturing, etc.

The storage section 7 includes a memory that stores captured images and videos, and a memory that stores programs and data required by the control section 2 to control each section of the electronic device 1. In particular, according to the present embodiment, the storage section 7 includes a set speed table for sound volume adjustment 71 and a set speed table for zoom amount adjustment 72. The set speed table for sound volume adjustment 71 is used to adjust sound volume during video playback or music playback. The set speed table for zoom amount adjustment 72 is used to adjust zoom amount during video image-capturing. The set speed table for sound volume adjustment 71 and the set speed table for zoom amount adjustment 72 are described in detail below.

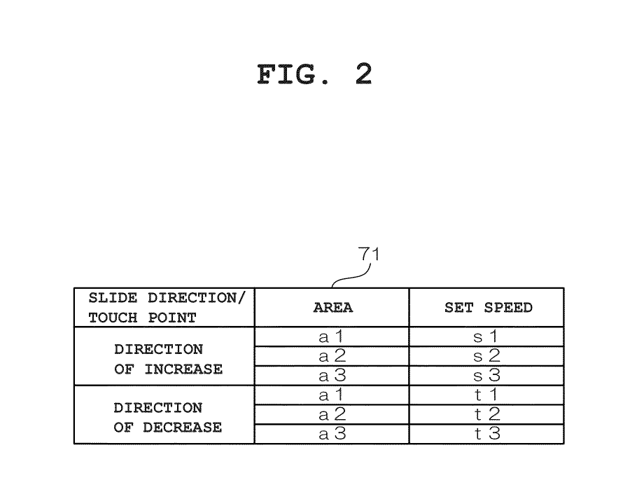

FIG. 2 is a conceptual diagram showing an example of the set speed table for sound volume adjustment 71 according to the present embodiment, which is used to adjust sound volume during video playback or music playback. In the set speed table for sound volume adjustment 71 included in the present embodiment, a volume adjustment range is divided into three areas, area a1, area a2, and area a3. In addition, set speed s1, set speed s2 and set speed s3 (direction of increase) are stored in correlation with area a1, area a2 and area a3 for the increase direction of a slide direction/touch point, respectively. Moreover, speed t1, speed t2 and speed t3 (direction of decrease) are stored in correlation with area a1, area a2 and area a3 for the decrease direction of the slide direction/touch point, respectively. The set speed s1, set speed s2 and set speed s3 (direction of increase) and the speed t1, speed t2 and speed t3 (direction of decrease) are threshold values for changing sound volume which are set in advance at the time of factory shipment. However, they may be set by the user.

When a sound volume adjustment slide bar (described hereafter) displayed on the touch display section 6 is slide-operated, the control section 2 references the above-described set speed table for sound volume adjustment 71 and acquires a set speed based on the area for which the slide operation has been performed. Then, when the slide speed is greater than the set speed, the control section 2 changes the sound volume at the set speed. Conversely, when the slide speed is less than the set speed, the control section 2 changes the sound volume at the slide speed. Also, when the sound volume adjustment slide bar displayed on the touch display section 6 is touch-operated, the control section 2 references the set speed table for sound volume adjustment 71, and after acquiring a set speed based on the area (point)) on which the touch operation has been performed, changes the sound volume at the set speed.

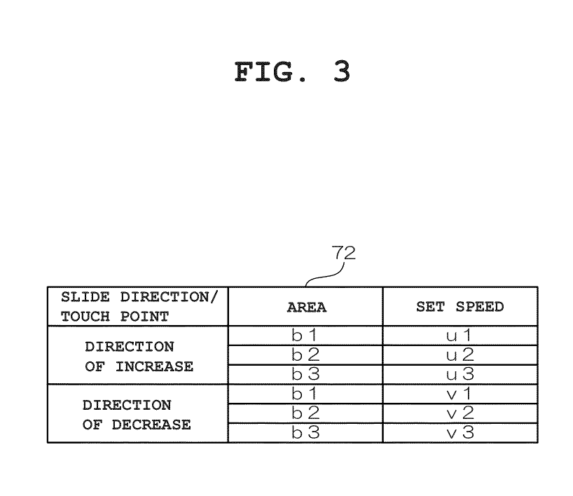

FIG. 3 is a conceptual diagram showing an example of the set speed table for zoom amount adjustment 72 according to the present embodiment, which is used for performing zoom adjustment during image-capturing. In the set speed table for zoom amount adjustment 72 included in the present embodiment, a zoom amount adjustment range is divided into three areas, area b1, area b2 and area b3, as in the case of the sound volume adjustment. In addition, set speed u1, set speed u2 and set speed u3 (direction of increase) are stored in correlation with area b1, area b2 and area b3 for the increase direction of a slide direction/touch point, respectively. Moreover, speed v1, speed v2 and speed v3 (direction of decrease) are stored in correlation with area b1, area b2 and area b3 for the decrease direction of the slide direction/touch point. The set speed u1, set speed u2 and set speed u3 (direction of increase) and the speed v1, speed v2 and speed v3 (direction of decrease) are set in advance at the time of factory shipment. However, they may be set by the user.

When a zoom amount adjustment slide bar (described hereafter) displayed on the touch display section 6 is slide-operated, the control section 2 references the above-described set speed table for zoom amount adjustment 72 and acquires a set speed based on the area on which the slide operation has been performed. Then, when the slide speed is greater than the set speed, the control section 2 changes the zoom amount at the set speed. Conversely, when the slide speed is less than the set speed, the control section 2 changes the zoom amount at the slide speed. Also, when the zoom amount adjustment slide bar displayed on the touch display section 6 is touch-operated, the control section 2 references the set speed table for zoom amount adjustment 72, and after acquiring a set speed based on the area (point) on which the touch operation has been performed, changes the zoom amount at the set speed.

Note that, as a result of the set speed being set to “0”, adjustment at a speed following the user's slide speed can be made at all times. This setting can be made for only a specific area, such as a low sound volume area where adverse effects are minimal, or the entire area in the decrease direction.

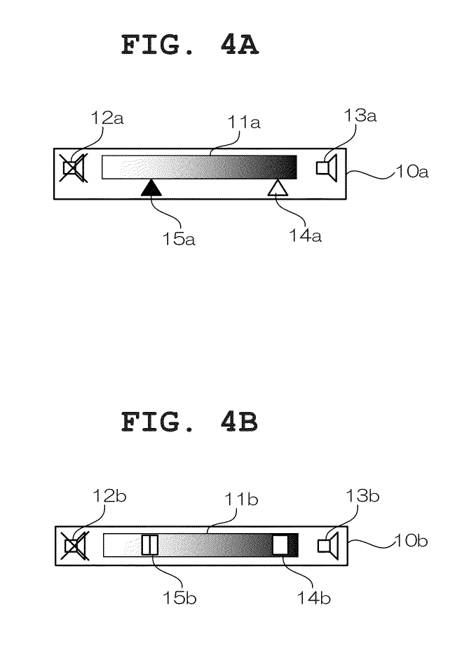

FIG. 4A and FIG. 4B are schematic diagrams showing examples of sound volume adjustment slide bars 10a. and 10b according to the present embodiment. The sound volume adjustment slide bar 10a shown in FIG. 4A is constituted by a slider 11a that indicates a sound volume setting range from mute (no sound) to maximum, icons 12a and 13a that indicate high and low volume levels, a first icon 14a that indicates a position corresponding to a user operation, and a second icon 15a that indicates a position corresponding to an actual volume level. Similarly, the sound volume adjustment slide bar 10b shown in FIG. 4B is constituted by a slider 11b that indicates a sound volume setting range from mute (no sound) to maximum, icons 12b and 13b that indicate high and low volume levels, a first icon 14b that indicates a position corresponding to a user operation, and a second icon 15b that indicates a position corresponding to an actual volume level.

In the sound volume adjustment slide bar 10a in FIG. 4A, the first icon 14a and the second icon 15b are arranged under the slider 11a. The sound volume adjustment slide bar 10b in FIG. 4B differs from the sound volume adjustment slide bar 10a in that the first icon 14b and the second icon 15b are arranged inside the slider 11b.

In both examples, the user adjusts the sound volume by slide-operating the first icon 14a or 14b in the right and left directions. In response, on the electronic device 1 side, the first icon 14a or 14b is moved in the right and left directions at the slide speed. When the slide speed is greater than a set speed that is based on an area where the operated first icon 14a or 14b is positioned, the sound volume is changed at the set speed, and the second icon 15a or 15b is moved in the right and left directions together with this change. Conversely, when the slide speed is less than the set speed, the sound volume is changed at the slide speed, and the second icon 15a or 15b is moved in the right and left directions together with this change.

Accordingly, the first icon 14a or 14b indicating a position corresponding to a user operation is not always in the same position as the second icon 15a or 15b indicating a position corresponding to an actual volume level, depending on the area where a slide operation is performed, the slide speed, and the set speed, as shown in FIG. 4A and FIG. 4B. The second icon 15a or 15b indicates a position corresponding to an actual volume level move, or in other words, an actual sound volume change, in such a manner to follow the movement of the first icon 14a or 14b indicating a position corresponding to a user operation.

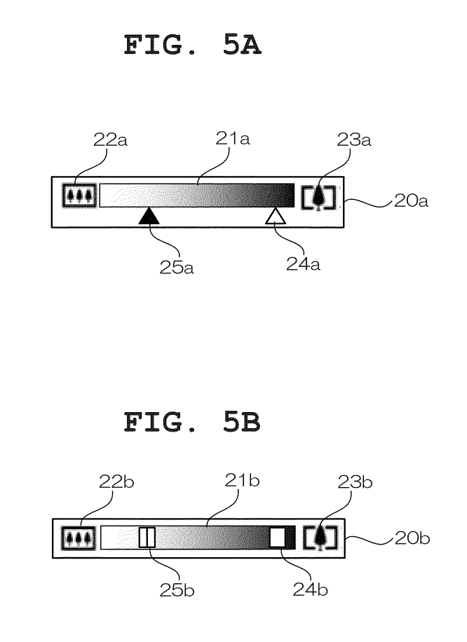

FIG. 5A and FIG. 5B are schematic diagrams showing examples of zoom amount adjustment slide bars 20a and 20b according to the present embodiment. The zoom amount adjustment slide bar 20a shown in FIG. 5A is constituted by a slider 21a that indicates a zoom setting range from the wide-angle end to the telephoto end, icons 22a and 23a that indicate the wide-angle end and the telephoto end, a first icon 24a that indicates a position corresponding to a user operation, and a second icon 25a that indicates a position corresponding to an actual zoom level.

Similarly, the zoom amount adjustment slide bar 20b shown in FIG. 5B is constituted by a slider 21b that indicates a zoom setting range from the wide-angle end to the telephoto end, icons 22b and 23b that indicate the wide-angle end and the telephoto end, a first icon 24b that indicates a position corresponding to a user operation, and a second icon 25b that indicates a position corresponding to an actual zoom level.

As in the case of FIG. 4A and FIG. 4B, FIG. 5A and FIG. 5B differ in that the first icon 24a and the second icon 25a are arranged under the slider 21a in the zoom amount adjustment slide bar 20a, and the first icon 24b and the second icon 25b are arranged inside the slider 21b in the zoom amount adjustment slide bar 20b.

In both examples, the user adjusts the zoom position by slide-operating the first icon 24a or 24b in the right and left directions. In response, on the electronic device 1 side, the first icon 24a or 24b is moved in the right and left directions at the slide speed. When the slide speed is greater than a set speed that is based on an area where the operated first icon 24a or 24b is positioned, the zoom amount is changed at the set speed, and the second icon 25a or 25b is moved in the right and left directions together with this change. Conversely, when the slide speed is less than the set speed, the zoom amount is changed at the slide speed, and the second icon 25a or 25b is moved in the right and left directions together with this change.

Therefore, the first icon 24a or 24b indicating a position corresponding to a user operation is not always in the same position as the second icon 25a or 25b indicating a position corresponding to an actual zoom level, depending on the area where a slide operation is performed, the slide speed, and the set speed, as shown in FIG. 5A and FIG. 5B. The second icon 25a or 25b indicates a position corresponding to an actual zoom level move, or in other words, an actual zoom amount change, in such a manner to follow the movement of the first icon 24a or 24b indicating a position corresponding to a zoom level set by a user operation.

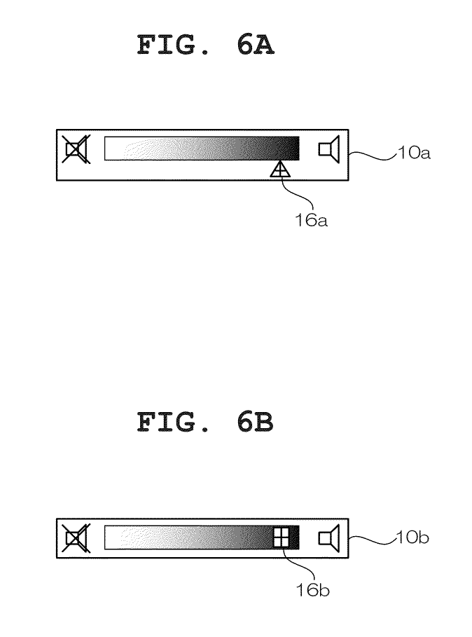

FIG. 6A and FIG. 6B are schematic diagrams showing other examples of the sound volume adjustment slide bars 10a and 10b according to the present embodiment. When the position of the first icon 14a or 14b coincides with the position of the second icon 15a or 15b in the above-described display aspects shown in FIG. 4A and FIG. 4B, the icons changes to a third icon 16a as shown in FIG. 6A or a third icon 16b as shown in FIG. 6B so that the user can easily recognize the overlapping of the icons.

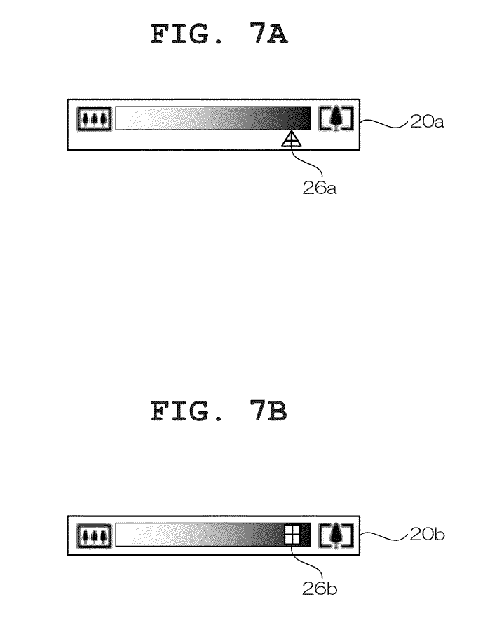

FIG. 7A and FIG. 7B are schematic diagrams showing other examples of the zoom amount adjustment slide bars 20a and 20b according to the present embodiment. When the position of the first icon 24a or 24b coincides with the position of the second icon 25a or 25b in the above-described display aspects shown in FIG. 5A and FIG. 5B, the icons changes to a third icon 26a as shown in FIG. 7A or a third icon 26b as shown in FIG. 7B so that the user can easily recognize the overlapping of the icons.

Note that, although the icons are changed to the third icon 16a, 16b, 26a or 26b in the examples of FIGS. 6A, 6B, 7A and 7B, the configuration of the present invention is not limited thereto, and the colors of the icons may be changed.

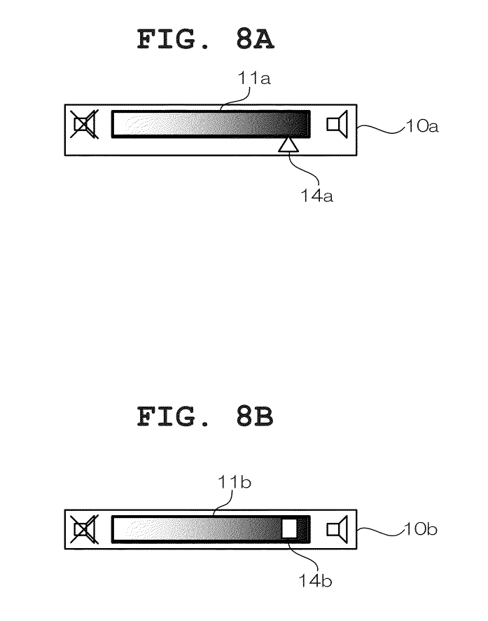

FIG. 8A and FIG. 8B are schematic diagrams showing other examples of the sound volume adjustment slide bars 10a and 10b according to the present embodiment. When the position of the first icon 14a or 14b coincides with the position of the second icon 15a or 15b in the above-described display aspects shown in FIG. 4A and FIG. 4B, the slider ha or lib is highlighted as shown in FIG. 8A and FIG. 8B so that the user can easily recognize the overlapping of the icons.

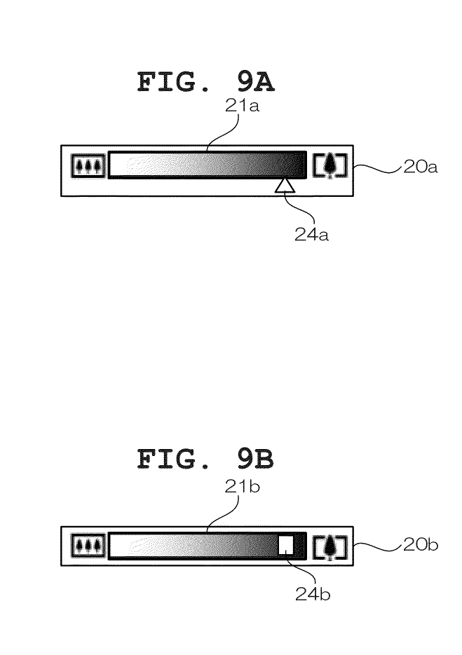

FIG. 9A and FIG. 9B are schematic diagrams showing other examples of the zoom amount adjustment slide bars 20a and 20b according to the present embodiment. When the position of the first icon 24a or 24b coincides with the position of the second icon 25a or 25b in the above-described display aspects shown in FIG. 5A and FIG. 5B, the slider 21a or 21b is highlighted as shown in FIG. 9A and FIG. 9B so that the user can easily recognize the overlapping of the icons.

Note that, although the slider 11a, 11b, 21a or 21b is highlighted in the examples of FIG. 8A, 8B, 9A or 9B, the configuration of the present invention is not limited thereto, and the colors of the sliders may be changed.

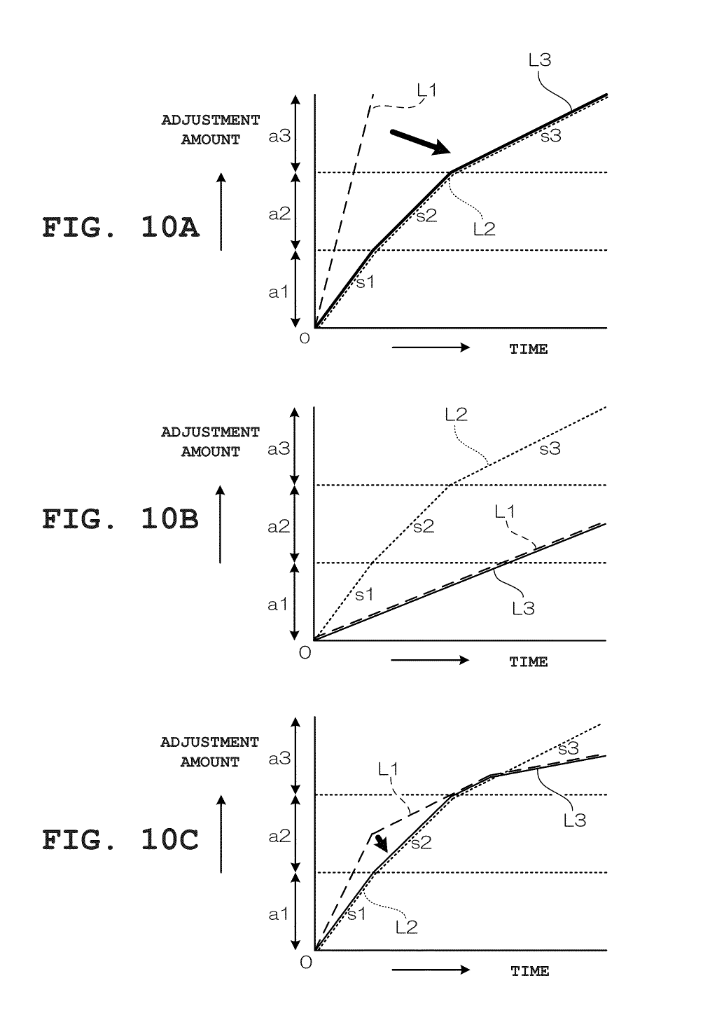

FIG. 10A, FIG. 10B and FIG. 10C are conceptual diagrams of slide speed, set speed, and actual change in sound volume when the sound volume is controlled in a direction of increase in the present embodiment. In FIG. 10A, FIG. 10B and FIG. 10C, the horizontal axis indicates time and the vertical axis indicates adjustment amount. The gradient of the line segment indicates speed of change. The greater the gradient, the greater the speed of change is. The dashed line L1 indicates slide speed, the dotted line L2 indicates set speed and the solid line L3 indicates actual speed of change in sound volume.

FIG. 10A shows an instance in which the slide speed L1 is faster than the set speed L2 (s1, s2, and s3) in all areas a1, a2, and a3, and therefore actual sound volume is changed in accordance with the solid line L3 (=set speed L2). FIG. 10B shows an instance in which the slide speed L1 is slower than the set speed L2 (s1, s2, and s3) in all areas a1, a2, and a3, and therefore actual sound volume is changed in accordance with the solid line L3 (=slide speed L1). In FIG. 10C, the slide speed L1 changes in the middle of the slide operation. It is faster than the set speed L2 (s1 and s2) in areas a1 and a2, becomes the same in a portion of area a3, and then becomes slower than the set speed L2 (s3). In areas a1 and a2, actual sound volume is changed in accordance with the solid line L3 (=set speed L2). In a portion of area a3 where the slide speed L1 and the set speed L2 are the same, the actual sound volume is changed at the slide speed L1 (=L2=L3). In the latter half of area a3, the actual sound volume is changed in accordance with the solid line L3 (=slide speed L1).

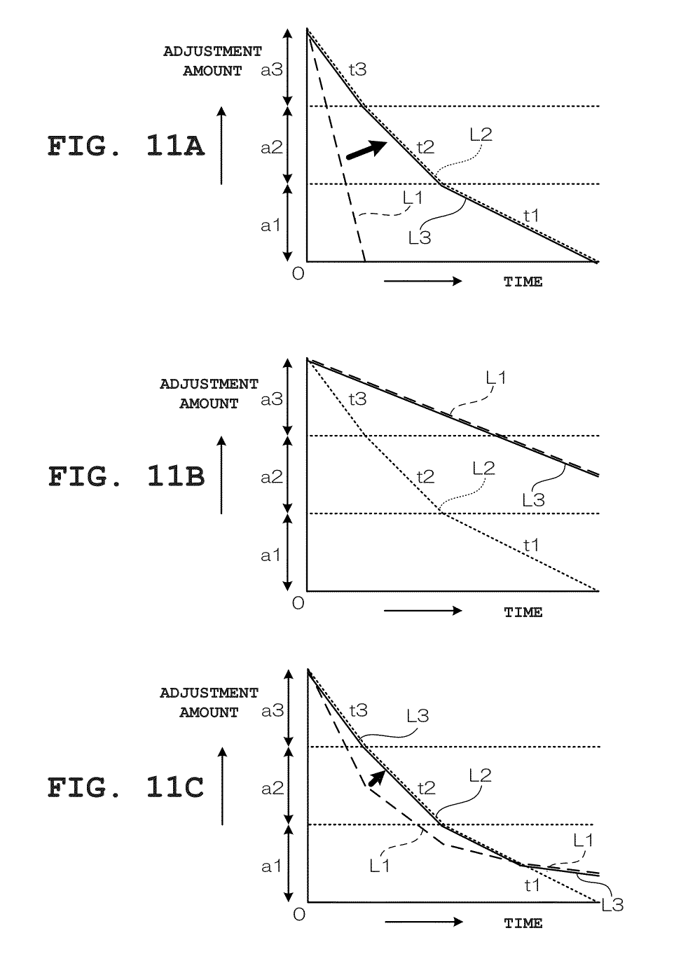

FIG. 11A, FIG. 11B, and FIG. 11C are conceptual diagrams of slide speed, set speed, and actual change in sound volume when the sound volume is controlled in a direction of decrease in the present embodiment. In FIG. 11A, FIG. 11B, and FIG. 11C, the horizontal axis indicates time and the vertical axis indicates adjustment amount. The gradient of the line segment indicates speed of change. The greater the gradient, the greater the speed of change is. The dashed line L1 indicates slide speed, the dotted line L2 indicates set speed, and the solid line L3 indicates actual speed of change in sound volume.

In FIG. 11A, the slide speed L1 is faster than the set speed L2 (t3, t2 and t1) in all areas a3 to a1, and therefore actual sound volume is changed in accordance with the solid line L3 (=set speed L2). In FIG. 11B, the slide speed L1 is slower than the set speed L2 (t3, t2 and t1) in all areas a3 to a1, and therefore actual sound volume is changed in accordance with the solid line L3 (=slide speed L1). In FIG. 11C, the slide speed L1 changes in the middle of the slide operation. It is faster than the set speed L2 (t3 and t2) in areas a3 and a2, and faster than the set speed L2 (t1) until the middle of area a1 is reached. When the middle of area a1 is reached, it becomes slower than the set speed L2 (t1). In this instance, from area a3 to the middle of a1, actual sound volume is changed in accordance with the solid line L3 (=set speed L2). Then, when the slide speed L1 becomes slower than the set speed L2 in area a1, the actual sound volume is changed in accordance with the solid line L3 (slide speed L1).

B. Operations of the Embodiment

Next, operations of the above-described embodiment will be described.

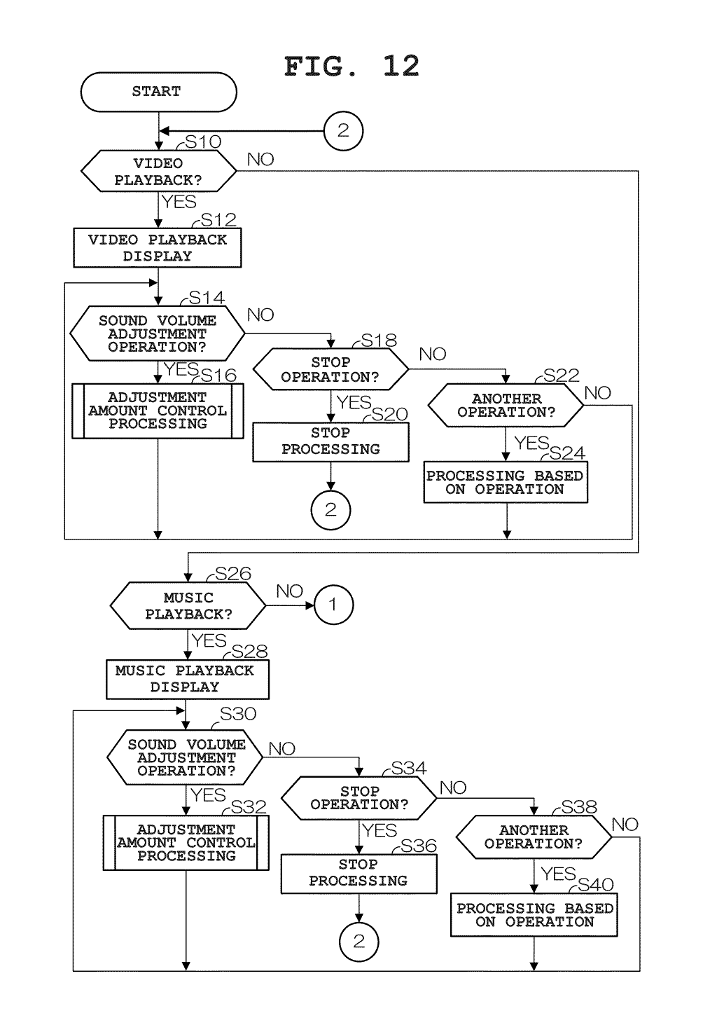

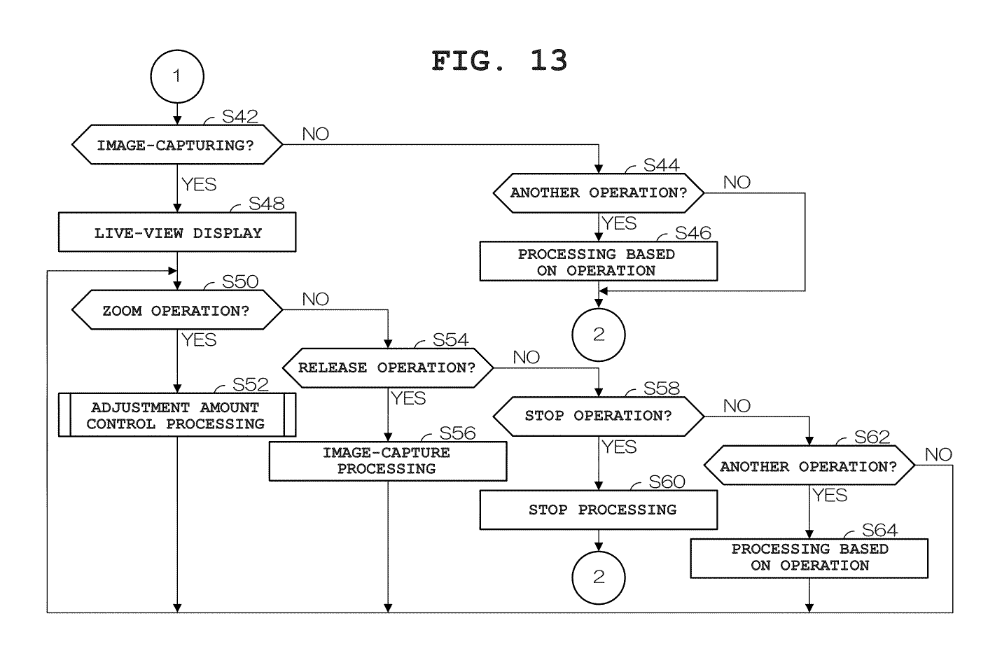

FIG. 12 and FIG. 13 are flowcharts of operations (main routine) of the electronic device 1 according to the present embodiment. First, the control section 2 judges whether or not video playback is performed (Step S10). When judged that the user has given an instruction to perform video playback (YES at Step S10), the control section 2 performs the playback of a video file specified by the user, and displays operation instruction icons for replaying, pausing, fast-forwarding, rewinding, and stopping the video file, and the sound volume adjustment slide bar 10a or 10b (see FIG. 4A, FIG. 4B, FIG. 6A and FIG. 6B) on the touch display section 6 (Step S12). Then, the control section 2 judges whether or not a sound volume adjustment operation has been performed during the playback (Step S14).

The sound volume adjustment operation herein refers to, for example, a slide operation in the right and left directions which is performed on the touch panel 61 by the user moving the first icon 14a of the sound volume adjustment slide bar 10a (see FIG. 4A) displayed on the display panel 62, or a touch operation that is performed on a point on the sound volume adjustment slide bar 10a which corresponds to a volume level to which the user wishes to set sound volume, in the example shown in FIG. 4A. When the user performs this sound volume adjustment operation during the playback (YES at Step S14), the control section 2 references the set speed table for sound volume adjustment 71 in FIG. 2, and performs adjustment amount control processing for adjusting the sound volume during the video playback, based on the area where the slide operation has been performed, the slide speed, the slide direction, and the set speed, or the point on which the touch operation has been performed, the increase/decrease direction, and the set speed (Step S16). Details of the adjustment amount control processing will be described hereafter. The control section 2 then returns to Step S14 and continues the video playback.

Conversely, when judged that the user has not performed a sound volume adjustment operation during the video playback (NO at Step S14), the control section 2 judges whether or not the user has performed a stop operation (Step S18). When judged that the user has performed a stop operation during the video playback (YES at Step S18), the control section 2 performs stop processing on the video being played back (Step S20), and returns to Step S10.

Also, when judged that neither a sound volume adjustment operation nor a stop operation has been performed during the video playback (NO at Step S18), the control section 2 judges whether or not another operation, such as an operation for fast-forwarding, rewinding or pausing the video, has been performed (Step S22). When judged that another operation has been performed (YES at Step S22), the control section 2 performs processing based on the performed operation (Step S24), and then returns to Step S14 to continue the video playback. Conversely, when judged that another operation has not been performed (NO at Step S22), the control section 2 returns to Step S14 without performing any processing, and continues the video playback.

At Step S10, when judged that the user has not given an instruction to perform video playback (NO at Step S10), the control section 2 judges whether or not the user has given an instruction to perform music playback (Step S26). When judged that the user has given an instruction to perform music playback (YES at Step S26), the control section 2 performs the playback of a music file specified by the user, and displays operation instruction icons for replaying, pausing, fast-forwarding, rewinding, and stopping the music file, and the sound volume adjustment slide bar 10a or 10b (see FIG. 4A, FIG. 4B, FIG. 6A and FIG. 6B) on the touch display section 6 (Step S28). Then, the control section 2 judges whether or not a sound volume adjustment operation has been performed during the music playback (Step S30).

The sound volume adjustment operation herein refers to, for example, a slide operation in the right and left directions which is performed on the touch panel 61 by the user moving the first icon 14a of the sound volume adjustment slide bar 10a (see FIG. 4A) displayed on the display panel 62, or a touch operation that is performed on a point on the sound volume adjustment slide bar 10a which corresponds to a volume level to which the user wishes to set sound volume, in the example shown in FIG. 4A. When the user performs this sound volume adjustment operation during the music playback (YES at Step S30), the control section 2 references the set speed table for sound volume adjustment 71 in FIG. 2, and performs adjustment amount control processing for adjusting the sound volume during the music playback, based on the area on which the slide operation has been performed, the slide speed, the slide direction and the set speed, or the point on which the touch operation has been performed, the increase/decrease direction, and the set speed (Step S32), Details of the adjustment amount control processing will be described hereafter. The control section 2 then returns to Step S30 and continues the music playback.

Conversely, when judged that the user has not performed a sound volume adjustment operation during the music playback (NO at Step S30), the control section 2 judges whether or not the user has performed a stop operation (Step S34). When judged that the user has performed a stop operation during the music playback (YES at Step S34), the control section 2 performs stop processing to stop the music playback (Step S36), and returns to Step S10 to repeat the above-described processing.

Also, when judged that neither a sound volume adjustment operation nor a stop operation has been performed during the music playback (NO at Step S34), the control section 2 judges whether or not another operation, such as an operation for fast-forwarding, rewinding or pausing the music, has been performed (Step S38). When judged that another operation has been performed (YES at Step S38), the control section 2 performs processing based on the performed operation (Step S40), and then returns to Step S30 to continue the music playback. Conversely, when judged that another operation has not been performed (NO at Step S38), the control section 2 returns to Step S30 without performing any processing, and continues the music playback.

At Step S26, when judged that neither an instruction to perform video playback nor an instruction to perform music playback has been given (NO at Step S26), the control section judges whether or not an instruction operation for image-capturing has been performed (Step S42 in FIG. 13). When judged that an instruction operation for image-capturing has not been performed (NO at Step S42), the control section 2 judges whether or not another operation, such as an operation for still-image playback or setting, has been performed (Step S44). When judged that another operation has been performed (YES at Step S44), the control section 2 performs processing based on the performed operation (Step S46), and then returns to Step S10 in FIG. 12 to repeat the above-described processing. Conversely, when judged that another operation has not been performed (NO at Step S44), the control section 2 returns to Step S10 without performing any processing, and repeats the above-described processing.

At Step S42, when judged that an instruction operation for image-capturing has been performed (YES at Step S42), the control section 2 outputs a captured image loaded by the imaging section 4 to the display panel 62, and performs live-view display (Step S48). During this live-view display, operation instruction icons for a release operation instructing the start of image-capturing, an end operation, still-image playback, setting, and the like, and the zoom amount adjustment slide bar 20a or 20b (see FIG. 5A, FIG. 5B, FIG. 7A and FIG. 7B) are displayed on the touch display section 6. Then, the control section 2 judges whether or not a zoom operation has been performed during the live-view display (Step S50).

The zoom operation herein refers to, for example, a slide operation in the right and left directions which is performed on the touch panel 61 by the user moving the first icon 24a of the zoom amount adjustment slide bar 20a (see FIG. 5A) displayed on the display panel 62, or a touch operation that is performed on a point on the zoom amount adjustment slide bar 20a which corresponds to a zoom level to which the user wishes to set zoom amount, in the example shown in FIG. 5A. When the user performs this zoom operation during the live-view display (YES at Step S50), the control section 2 references the set speed table for zoom amount adjustment 72 in FIG. 3 and performs adjustment amount control processing for adjusting the zoom amount based on the area where the slide operation has been performed, the slide speed, the slide direction, and the set speed, or the point on which the touch operation has been performed, the increase/decrease direction, and the set speed (Step S52). Details of the adjustment amount control processing will be described hereafter. The control section 2 then returns to Step S50 and continues the image-capturing operation.

Conversely, when judged that the user has not performed a zoom operation during the live-view display (NO at Step S50), the control section 2 judges whether or not the user has performed a release operation (Step S54). When judged that the user has performed a release operation during the live-view display (YES at Step S54), the control section 2 controls the imaging section 4 to perform scene setting, exposure adjustment, etc., and performs image-capturing (Step S56). Then, the control section 2 returns to Step S50 and continues the image-capturing processing.

Conversely, when judged that neither a zoom operation nor a release operation has been performed (NO at Step S54), the control section 2 judges whether or not the user has performed a stop operation (Step S58). When judged that the user has performed a stop operation during the live-view display or image-capturing (YES at Step S58), the control section 2 performs stop processing to stop the image-capturing (Step S60), and returns to Step S10 in FIG. 2 to repeat the above-described processing.

Conversely, when judged that none of a zoom operation, a release operation or a stop operation has been performed during the live-view display or image-capturing (NO at Step S58), the control section 2 judges whether or not another operation, such as an operation for scene setting or exposure control, has been performed (Step S62). When judged that another operation has been performed (YES at Step S62), the control section 2 performs processing based on the performed operation (Step S64), and then returns to Step S50 to continue the image-capturing processing. Conversely, when judged that another operation has not been performed (NO at Step S62), the control section 2 returns to Step S50 without performing any processing, and continues the image-capturing.

Next, operations of the above-described adjustment amount control processing will be described.

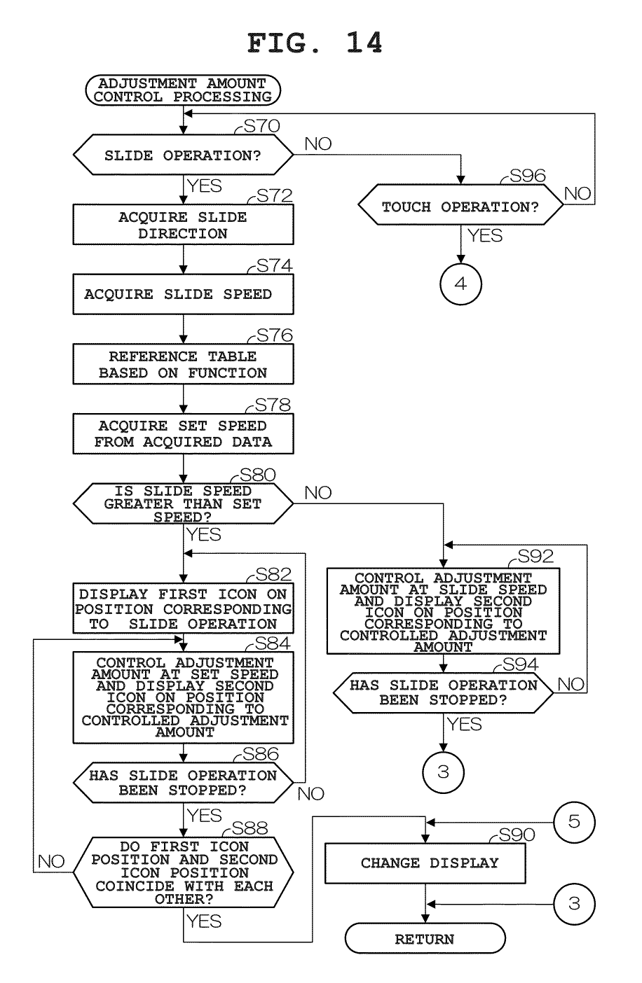

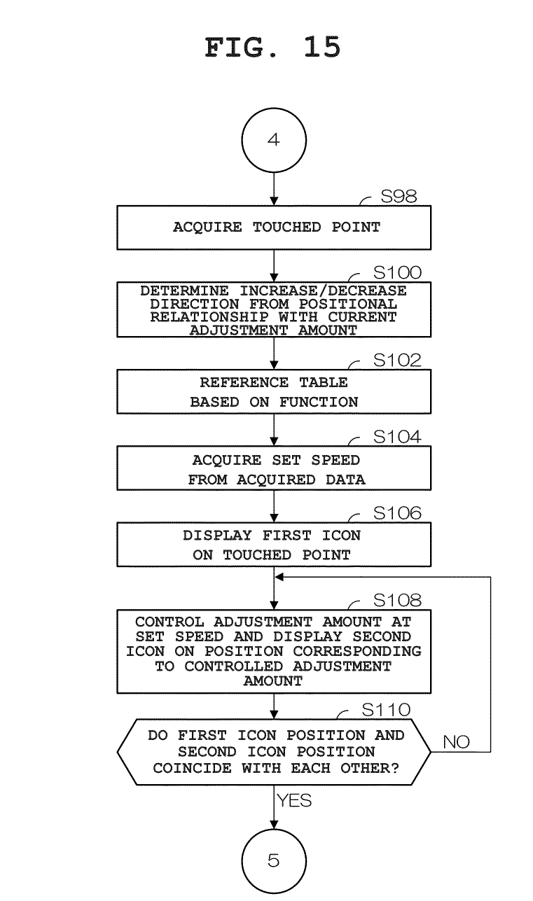

FIG. 14 and FIG. 15 are flowcharts for explaining the operation of the adjustment amount control processing according to the present embodiment. In the adjustment amount control processing, the control section 2 first judges whether or not the user has performed a slide operation by using the sound volume adjustment slide bar 10a (10b) or the zoom amount adjustment slide bar 20a (20b) (Step S70). When judged that the user has performed a slide operation (YES at Step S70), the control section 2 acquires the slide direction (Step S72) and the slide speed (Step S74). Then, the control section 2 references the set speed table for sound volume adjustment 71 or the set speed table for zoom amount adjustment 72 in accordance with the function being used (Step S76), and acquires a set speed that corresponds to the slide direction and the slide speed (which changes depending on the area where the slide operation has been performed) (Step S78).

Next, the control section 2 judges whether or not the slide speed is greater than the set speed (Step S80). When judged that the slide speed is greater than the set speed, as shown in area a1 to the middle of a3 in FIG. 10A and FIG. 10C, and areas a3 to the middle of a1 in FIG. 11A and FIG. 11C (YES at Step S80), the control section 2 displays the first icon 14a (14b, 24a or 24b) on a position corresponding to the slide operation (Step S82), controls the adjustment amount (sound volume or zoom amount) at the set speed, and displays the second icon 15a (15b, 25a or 25b) on a position corresponding to the controlled adjustment amount (Step S84). Then, the control section 2 judges whether or not the user has stopped the slide operation (Step S86). When judged that the user is continuing the slide operation (NO at Step S86), the control section 2 returns to Step S82 and performs the sequential update of the control of the adjustment amount (sound volume or zoom amount) and the sequential update of the display of the first icon and the second icon.

Conversely, when judged that the user has stopped the slide operation (YES at Step S86), the control section 2 judges whether or not the position of the first icon 14a (14b, 24a or 24b) coincides with the position of the second icon 15a (15b, 25a or 25b) (Step S88). When judged that the position of the first icon 14a (14b, 24a or 24b) does not coincide with the position of the second icon 15a (15b, 25a or 25b) (NO at Step S88), the control section 2 returns to Step S84 and performs the sequential update of the control of the adjustment amount (sound volume or zoom amount) and the sequential update of the display of the second icon. Then, when judged that the position of the first icon 14a (14b, 24a or 24b) coincides with the position of the second icon 15a (15b, 25a or 25b) (YES at Step S88), the control section 2 changes the display of the icons to the third icon 16a (16b, 26a or 26b) as shown in FIG. 6A, FIG. 6B, FIG. 7A and FIG. 7B, or changes the display of the slider as shown in FIG. 8A, FIG. 8B, FIG. 9A and FIG. 9B (Step S90), and then returns to the main routine.

At Step S80, when judged that the slide speed is not greater than the set speed as shown from the middle of area a3 in FIG. 10B and FIG. 10C, or from the middle of area a1 in FIG. 11B and FIG. 11C (NO at Step S80), the control section 2 controls the adjustment amount (sound volume or zoom amount) at the slide speed, and displays the second icon 15a (15b, 25a or 25b) on a position corresponding to the controlled adjustment amount (Step S92). Then, the control section 2 judges whether or not the user has stopped the slide operation (Step S94). When judged that the user is continuing the slide operation (NO at Step S94), the control section 2 returns to Step S92 and performs the sequential update of the control of the adjustment amount (volume or zoom) at the slide speed and the sequential update of the display of the second icon. When judged that the user has stopped the slide operation (YES at Step S94), the control section 2 stops the processing and returns to the main routine.

At Step S70, when judged that the user has not performed a slide operation by the sound volume adjustment slide bar 10a (10b) or the zoom amount adjustment slide bar 20a (20b) (NO at Step S70), the control section 2 judges whether or not the user has performed a touch operation (Step S96). When judged that the user has not performed a touch operation (NO at Step S96), the control section 2 returns to Step S70 and waits until the user performs a slide operation or a touch operation.

Conversely, when judged that the user has performed a touch operation (YES at Step S96), the control section 2 acquires the touched point (Step S98 in FIG. 15), and determines the increase/decrease direction from the positional relationship between the touched point and the current adjustment amount (second icon 15a or 15b: sound volume: second icon 25a or 25b zoom amount) (Step S100). Then, the control section 2 references the set speed table for sound volume adjustment 71 or the set speed table for zoom amount adjustment 72 in accordance with the function being used (Step S102), and acquires a set speed that corresponds to the increase/decrease direction and the touched point (Step S104).

Next, the control section 2 displays the first icon 14a (14b, 24a or 24b) on the touched point (Step S106), controls the adjustment amount (volume or zoom) at the set speed, and displays the second icon 15a (15b, 25a or 25b) on a position corresponding to the controlled adjustment amount (Step S108). Then, the control section 2 judges whether or not the position of the first icon 14a (14b, 24a or 24b) coincides with the position of the second icon 15a (15b, 25a or 25b) (Step S110). When judged that the position of the first icon 14a (14b, 24a or 24b) does not coincide with the position of the second icon 15a (15b, 25a or 25b) (NO at Step S110), the control section 2 returns to Step S108 and performs the sequential update of the control of the adjustment amount (sound volume or zoom amount) and the sequential update of the display of the second icon.

Then, when judged that the position of the first icon 14a (14b, 24a or 24b) coincides with the position of the second icon 15a (15b, 25a or 25b) (YES at Step S110), the control section 2 proceeds to Step S90 in FIG. 14 described earlier, and after changing the display of the icons to the third icon 16a (16b, 26a or 26b) as shown in FIG. 6A, FIG. 6B, FIG. 7A and FIG. 7B, or changing the display of the slider as shown in FIG. 8A, FIG. 8B, FIG. 9A and FIG. 9B, returns to the main routine.

Note that, although change in control amount is instructed by the touch panel 61 being touched (slide operation or touch operation) in the above-described embodiment, the present invention is not limited thereto, and a mouse or the like may be used.

Also note that the present invention may be applied to the adjustment of water content, air-flow rate, temperature, lens movement amount, etc., in addition to the adjustment of sound volume or zoom amount.

According to the above-described embodiment, a slider for adjusting an adjustment amount for a function provided by the electronic device 1 is displayed on the display panel 62, and an adjustment position corresponding to the slide operation performed on the slider by the user operating the touch panel 61 is displayed in association with the slider. In addition, whether or not the speed of the slide operation performed by the user is faster than a preset speed is judged. When it is judged that the speed of the slide operation performed by the user is faster than the set speed, the adjustment amount is controlled to be changed at a speed slower than the speed of the slide operation performed by the user, and a position corresponding to the controlled adjustment amount is displayed in association with the slider. Therefore, even when the user rapidly adjusts an adjustment amount, the change in the adjustment amount is restricted to be slower than the speed of the slide operation performed by the user, whereby discomfort to or adverse effects on the user are prevented.

In addition, when it is judged that the speed of the slide operation performed by the user is faster than the set speed, the adjustment amount is controlled based on the set speed. Conversely, when it is judged that the speed of the slide operation performed by the user is equal to or less than the set speed, the adjustment amount is controlled based on the speed of the slide operation performed by the user. Therefore, even when the user rapidly adjusts an adjustment amount, the change in the adjustment amount is restricted to be performed at the set speed, whereby discomfort to or adverse effects on the user are prevented. In addition, because the user's desired adjustment amount and the current adjustment amount can be simultaneously known, the user can perform adjustment with minimal stress.

Moreover, when it is judged that the speed of the slide operation performed by the user is equal to or less than the set speed, the adjustment amount is changed to a level corresponding to the indicated adjustment position is reached, and the change is stopped thereafter. Therefore, adjustment amount can be unfailingly adjusted to an adjustment amount desired by the user.

Also, in the above-described embodiment, a set speed is set for each of a plurality of areas created by the adjustment range of an adjustment amount being divided, and whether or not the speed of a slide operation performed by the user is faster than the set speed of an area corresponding to the slide operation is judged. Therefore, in the case of sound volume adjustment for example, if a high speed is set as a set speed for a low sound volume area where discomfort and adverse effects are insignificant even when the speed of sound volume change is fast, and a low speed is set as a set speed for a high sound volume area where discomfort and adverse effects are significant when the speed of sound volume change is fast, adjustment can be performed with minimal stress while preventing discomfort and adverse effects.

In addition, when the user performs a position specifying operation for directly specifying an adjustment position, an adjustment position based on the position specifying operation is displayed in association with the slider, and the speed of the position specifying operation is judged to be faster than the set speed. Then, the adjustment amount is changed to a level corresponding to the displayed adjustment position based on the set speed, and the change is stopped thereafter. Therefore, even when a slide operation is not performed and a position corresponding to an adjustment level to which the user wishes to make an adjustment is directly specified by a position specifying operation, adjustment can be performed with minimal stress while preventing discomfort and adverse effects.

Moreover, when an adjustment position corresponding to a user operation coincides with the actual adjustment position, the display aspect of each adjustment position is changed. Therefore, whether an adjustment amount is a certain adjustment amount or is in the process of being changed can be recognized at a glance.

Furthermore, when an adjustment position corresponding to a user operation coincides with the actual adjustment position, the display method of each adjustment position is changed, whereby the display aspect of the displayed slider is changed. Therefore, whether an adjustment amount is a certain adjustment amount or is in the process of being changed can be recognized at a glance.

Still further, the speed of change in adjustment amount set in advance can be set by the user. Therefore, adjustment that suits the preference of the user and is less stressful can be performed.

Yet still further, set speed can be set such that a set speed for a direction where adjustment amount is increased and a set speed for a direction where adjustment amount is decreased are different. Therefore, adjustment can be made using a more natural adjustment amount.

Yet still further, sound volume when outputting audio is adjusted. Therefore, sound volume can be adjusted using a more natural adjustment amount, while preventing discomfort and adverse effects.

Yet still further, the amount of zoom during image-capturing is adjusted. Therefore, the amount of zoom can be adjusted using a more natural adjustment amount, while preventing discomfort and adverse effects.

Yet still further, position specifying operations are performed using a touch panel. Therefore, in widely used devices including touch panels, the amount of zoom can be adjusted using a more natural adjustment amount, while preventing discomfort and adverse effects.

While the present invention has been described with reference to the preferred embodiments, it is intended that the invention be not limited by any of the details of the description therein but includes all the embodiments which fall within the scope of the appended claims.

What is claimed is:

1. An electronic device comprising:
a display section;
a position specifying section which specifies a position on the display section;
a slider display section which displays on the display section a slider for adjusting an adjustment amount of a function provided by the electronic device;
an adjustment position display section which displays an adjustment position corresponding to the position specified by a slide operation performed on the slider by a user using the position specifying section, in association with the slider displayed by the slider display section;
a judging section which judges whether a speed of the slide operation by the user is faster than a predetermined speed of change for the adjustment amount;
a control section which controls the adjustment amount to be changed at a speed slower than the speed of the slide operation by the user, when the judging section judges that the speed of the slide operation by the user is faster than the predetermined speed of change for the adjustment amount; and
a control position display section which displays a position corresponding to the adjustment amount controlled by the control section, in association with the slider.

2. The electronic device according to claim 1, wherein the control section (i) controls the adjustment amount based on the predetermined speed of change for the adjustment amount when the judging section judges that the speed of the slide operation by the user is faster than the predetermined speed of change for the adjustment amount, and (ii) controls the adjustment amount based on the speed of the slide operation by the user when the judging section judges that the speed of the slide operation by the user is slower than the predetermined speed of change for the adjustment amount.

3. The electronic device according to claim 2, wherein the control section (i) changes the adjustment amount to a level corresponding to the adjustment position displayed by the adjustment position display section, at a speed corresponding to the speed of the slide operation by the user, and then (ii) stops change of the adjustment amount, when the judging section judges that the speed of the slide operation by the user is slower than the predetermined speed of change for the adjustment amount.

4. The electronic device according to claim 1, wherein the predetermined speed of change for the adjustment amount is settable for each of a plurality of areas created by dividing an adjustment range of the adjustment amount; and
the judging section judges whether the speed of the slide operation by the user is faster than a speed of change in the adjustment amount which has been set for an area corresponding to the slide operation.

5. The electronic device according to claim 3, further comprising:
a match judging section which judges whether the adjustment position displayed by the adjustment position display section coincides with the position displayed by the control position display section; and
a display aspect changing section which changes display aspects of the adjustment position displayed by the adjustment position display section and the position displayed by the control position display section, when the match judging section judges that the adjustment position displayed by the adjustment position display section coincides with the position displayed by the control position display section.

6. The electronic device according to claim 3, further comprising:
a match judging section which judges whether the adjustment position displayed by the adjustment position display section coincides with the position displayed by the control position display section; and
a slider display aspect changing section which changes a display aspect of the slider displayed by the slider display section, when the match judging section judges that the adjustment position displayed by the adjustment position display section coincides with the position displayed by the control position display section.

7. The electronic device according to claim 1, wherein the predetermined speed of change for the adjustment amount is settable by a user.

8. The electronic device according to claim 1, wherein the predetermined speed of change for the adjustment amount is set such that (i) a set speed for a direction where the adjustment amount is increased and (ii) a set speed for a direction where the adjustment amount is decreased are different.

9. The electronic device according to claim 1, wherein the function is a function for outputting audio, and the adjustment amount is sound volume of the audio outputted by the function.

10. The electronic device according to claim 1, wherein the function is an image-capturing function, and the adjustment amount is a zoom adjustment amount in the image-capturing function.

11. The electronic device according to claim 1, wherein the position specifying section is a touch panel.

12. An electronic device comprising:
a display section;
a position specifying section which specifies a position on the display section;
a slider display section which displays on the display section a slider for adjusting an adjustment amount of a function provided by the electronic device;
an adjustment position display section which displays an adjustment position corresponding to a position specifying operation performed on an adjustment position on the slider by a user using the position specifying section, in association with the slider displayed by the slider display section;
a judging section which judges whether an operation performed on the slider by the user is a position specifying operation on an adjustment position;
a control section which (i) controls the adjustment amount to be changed to a level corresponding to the adjustment position displayed by the adjustment position display section, at a speed corresponding to a predetermined speed of change for the adjustment amount, and (ii) stops change of the adjustment amount, when the judging section judges that the operation performed on the slider by the user is a position specifying operation on an adjustment position; and
a control position display section which displays a position corresponding to the adjustment amount controlled by the control section, in association with the slider.

13. The electronic device according to claim 12, further comprising:
a match judging section which judges whether the adjustment position displayed by the adjustment position display section coincides with the position displayed by the control position display section; and
a display aspect changing section which changes display aspects of the adjustment position displayed by the adjustment position display section and the position displayed by the control position display section, when the match judging section judges that the adjustment position displayed by the adjustment position display section coincides with the position displayed by the control position display section.

14. The electronic device according to claim 12, further comprising:
a match judging section which judges whether the adjustment position displayed by the adjustment position display section coincides with the position displayed by the control position display section; and
a slider display aspect changing section which changes a display aspect of the slider displayed by the slider display section, when the match judging section judges that the adjustment position displayed by the adjustment position display section coincides with the position displayed by the control position display section.

15. A method of controlling an adjustment amount in an electronic device including a display section and a position specifying section which specifies a position on the display section, comprising:
a slider display step of displaying on the display section a slider for adjusting an adjustment amount of a function provided by the electronic device;
an adjustment position display step of displaying an adjustment position corresponding to the position specified by a slide operation performed on the slider by a user using the position specifying section, in association with the slider displayed in the slider display step;
a judging step of judging whether a speed of the slide operation by the user is faster than a predetermined speed of change for the adjustment amount;
a control step of controlling the adjustment amount to be changed at a speed slower than the speed of the slide operation by the user, when the speed of the slide operation by the user is judged to be faster than the predetermined speed of change for the adjustment amount in the judging step; and
a control position display step of displaying a position corresponding to the adjustment amount controlled in the control step, in association with the slider.

16. A method of controlling an adjustment amount in an electronic device including a display section and a position specifying section which specifies a position on the display section, comprising:
a slider display step of displaying on the display section a slider for adjusting an adjustment amount of a function provided by the electronic device;
an adjustment position display step of displaying an adjustment position corresponding to a position specifying operation performed on an adjustment position on the slider by a user using the position specifying section, in association with the slider displayed in the slider display step;
a judging step of judging whether an operation performed on the slider by the user is a position specifying operation on an adjustment position;
a control step of (i) controlling the adjustment amount to be changed to a level corresponding to the adjustment position displayed in the adjustment position display step, at a speed corresponding to a predetermined speed of change for the adjustment amount, and (ii) stopping change of the adjustment amount, when the operation performed on the slider by the user is judged to be a position specifying operation on an adjustment position in the judging step; and
a control position display step of displaying a position corresponding to the adjustment amount controlled in the control step, in association with the slider.

17. A non-transitory computer-readable storage medium having stored thereon a program that is executable by a computer in an electronic device including a display section and a position specifying section which specifies a position on the display section, the program being executable by the computer to perform functions comprising:
a slider display function for displaying on the display section a slider for adjusting an adjustment amount of a function provided by the electronic device;
an adjustment position display function for displaying an adjustment position corresponding to the position specified by a slide operation performed on the slider by a user using the position specifying section, in association with the slider displayed by the slider display function;
a judging function for judging whether a speed of the slide operation by the user is faster than a predetermined speed of change for the adjustment amount;
a control function for controlling the adjustment amount to be changed at a speed slower than the speed of the slide operation by the user, when the speed of the slide operation by the user is judged by the judging function to be faster than the predetermined speed of change for the adjustment amount; and
a control position display function for displaying a position corresponding to the adjustment amount controlled by the control function, in association with the slider.

18. A non-transitory computer-readable storage medium having stored thereon a program that is executable by a computer in an electronic device including a display section and a position specifying section which specifies a position on the display section, the program being executable by the computer to perform functions comprising:
a slider display function for displaying on the display section a slider for adjusting an adjustment amount of a function provided by the electronic device;
an adjustment position display function for displaying an adjustment position corresponding to a position specifying operation performed on an adjustment position on the slider by a user using the position specifying section, in association with the slider displayed by the slider display function;
a judging function for judging whether an operation performed on the slider by the user is a position specifying operation on an adjustment position;
a control function for (i) controlling the adjustment amount to be changed to a level corresponding to the adjustment position displayed by the adjustment position display function, at a speed corresponding to a predetermined speed of change for the adjustment amount, and (ii) stopping change of the adjustment amount, when the operation performed on the slider by the user is judged by the judging function to be a position specifying operation on an adjustment position; and
a control position display function for displaying a position corresponding to the adjustment amount controlled by the control function, in association with the slider.
